(19) United States
(12) Patent Application Publication
(10) Pub. No.: US 2008/0073284 A1
(43) Pub. Date: Mar. 27, 2008

(54) DEVICE AND METHOD FOR UTILIZING MAGNETIC SEEDING AND SEPARATION IN A WATER TREATMENT SYSTEM

(76) Inventor: Steven L. Cort, Cary, NC (US)

Correspondence Address: Coats & Bennett, PLLC/Michael deAngeli, 1400 Crescent Green, Suite 300, Cary, NC, 27581, US

(21) Appl. No.: 11/862,798

(22) Filed: Sep. 27, 2007

Related U.S. Application Data
(60) Provisional application No. 60/847,372, filed on Sep. 27, 2006.

(51) Int. Cl. B03C 1/30

(52) U.S. Cl. 210/695; 210/207

(57) ABSTRACT

Tank designs for magnetic seeding and separation for cleaning water. Magnetic seed are added to water to be treated and form magnetic composite particles or floc comprising the magnetic seed and pollutant particles bound thereto. Moving magnetized surfaces are utilized to collect the magnetic floc from the water to produce cleaned water. The magnetic floc are processed to separate the magnetic seed from a sludge which is ejected. Magnetized surfaces include rotating drums, disks, and walls or panels and moving magnetized belts.

### CROSS-REFERENCE TO RELATED APPLICATION

This application claims priority under 35 U.S.C. § 119(e) from the following U.S. provisional application: Application Ser. No. 60/847,372 filed on Sep. 27, 2006. That application is incorporated in its entirety by reference herein.

### FIELD OF THE INVENTION

The present invention relates to water treatment, particularly to the use of magnetic seeding and separation to clean water.

### BACKGROUND OF THE INVENTION

Briefly, “magnetic seeding and separation” technology as referred to herein involves adding a magnetic seed material to water that contains fine pollutant particles. The magnetic seed material is attached under agitation to the pollutant particles with an organic flocculating agent. The flocculated particles are now magnetic and are removed from the water with either permanent magnets or electromagnets.

A known commercial application of magnetic seeding is the “Sirofloc” technology used in Australia to clean drinking water. This process uses the absorption capacity of magnetite to remove color and other pollutants from water. The spent magnetic seed material magnetite settles out by gravity in a clarifier and then is pumped to a magnetite regeneration step that cleans the magnetite so it can be reused.

Another known commercial application of magnetic seeding is the “Comag” process described in Wechsler U.S. Pat. No. 6,099,738. This process has a high gradient magnetic field collector that uses powerful electromagnets. Once the collector becomes loaded with solids, it is backwashed with air and water to flush the magnetic seed material to a cleaning process. The cleaned magnetic seed material is then reused in the treatment process. The electromagnets in the Comag system have to be de-energized for cleaning. The cleaning process interrupts the flow of water for treatment and high solids loading limits the ability to backwash the system.

### SUMMARY OF THE INVENTION

A method of treating water utilizing magnetic seeding and magnetic separation is disclosed. The method includes mixing magnetic seed and a flocculant with the water to be treated to form magnetic floc. The magnetic floc is collected on a magnetic collector that extends substantially around an upper perimeter portion of a tank that contains the water to be treated and the formed magnetic floc. After the floc has been collected by the magnetic collector, the magnetic floc is removed from the magnetic collector.

In one embodiment, the magnetic collector includes a bed of magnetized particles and the method includes directing the water to be treated through the bed of magnetized particles and collecting magnetic floc on the magnetized particles.

In another embodiment, a similar method of treating the water is disclosed, but in this case a magnetized endless belt is submerged in the water. During the water treating process, the magnetized belt is driven through the water, and in the process magnetic floc in the water is collected on the endless magnetized belt and transported out of the water being treated and eventually removed from the endless belt.

Other objects and advantages of the present invention will become apparent and obvious from a study of the following description and the accompanying drawings which are merely illustrative of such invention.

### BRIEF DESCRIPTION OF THE DRAWINGS

FIG. 1 is a schematic plan view of a flocculation tank with a final magnetic collector disposed about an upper perimeter of the tank.

FIG. 2 is a schematic plan view of a flocculation tank with an alternate embodiment of a magnetic collector disposed about an upper perimeter of the tank.

FIG. 3 is a schematic side elevation view of an apparatus according to one aspect of the invention, with a magnetic separator device mounted in the upper portion of a flocculation tank.

FIG. 4 is a schematic plan view of an apparatus according to one embodiment with a stationary continuous cleaner and a moving magnetic collector bed.

FIG. 5 is a schematic plan view of an apparatus according to one embodiment with a moving continuous cleaner and a stationary magnetic collector bed.

FIG. 6 is a schematic side elevation of an apparatus according to one embodiment with a moving magnetic belt collector.

FIG. 7 is a front elevation view of the moving magnetic belt collector.

FIG. 8 is a side elevation view of an apparatus according to one embodiment where the final collector comprises a bed of magnets supported on a screen in an annular trough extending around an upper portion of a tank.

FIG. 9 is a side elevation view of an apparatus according to one embodiment where the final collector comprises a buoyant bed of magnets supported in an annular trough extending around an upper portion of a tank.

### DETAILED DESCRIPTION OF THE INVENTION

The present invention is in the technical field of removing fine particles from water. The fine particles can include metal precipitates, organic solids, inorganic solids, clays, silts, oil and grease and any other hard to remove fine solids. The invention is applicable to industrial wastewater, municipal wastewater, potable water, combined sewer overflow, storm water, process water, cooling water, ground water, and any other waters that require clarification to remove fine particles. The term “water” as used herein includes water and all forms of wastewater.

The invention relates to the use of magnetic seeding and separation technology where a fine magnetic seed material is added to the water along with an organic flocculating polymer. The organic flocculating polymer binds the non-magnetic pollutant particles to the magnetic seed material and forms a magnetic composite particle, or magnetic floc. In some embodiments, a flocculating polymer may not be used but rather the sorption properties of the magnetic particles are employed to extract pollutants from the water and attach the pollutants to the magnetic seed material. In some cases, certain scalants may be removed by employing magnetic particles whose surfaces provide sites for sacrificial scaling thus preventing or reducing scaling on downstream equipment. In any case, the processes disclosed herein utilize the magnetic properties of the magnetic seed, bound with pollutants—be they in the form of flocs, particles with pollutants sorbed therewith, or scaled magnetic particles—to magnetically remove the pollutants from the water.

Collectors employing magnetized surfaces are used to attract magnetic composite particles. The magnetized surfaces are generally moving magnetized surfaces to facilitate continuous transport of collected particles out of the water. The surfaces are equipped with permanent magnets or electromagnets to provide the required magnetic strength to remove the magnetic particles. The magnetic strength of the magnets typically used ranges from approximately 0.1 to 10 tesla. Permanent magnets may be more commonly 0.5 to 1.5 tesla while electromagnets may be configured with a strength up to about 10 tesla.

The collected magnetic floc are further processed to form separate streams of sludge to be ejected as a waste product and cleaned magnetic seed that is recycled and reused in the water treatment system.

The process of using magnetic seeding and separation technology for removing fine pollutant particles sometimes involves attaching the fine pollutant particles to the magnetic seed material with a flocculating polymer. In a traditional flocculation process, the aim is often to produce a large floc that will settle rapidly by gravity. To assure this floc formation, it is important to have the proper mixing energy. The measure of this mixing energy is referred to as the root-mean-square velocity gradient G measured in negative seconds (sec⁻¹). For optimum floc formation in a gravity separation situation, the G value should not exceed approximately 50 sec⁻¹. Exceeding this level increases the speed of mixing and the formation of microfloc, but will shear the floc and prevent the development of large macroflocs that tend to settle rapidly.

Magnetic seeding and separation is different. Since the size of floc is not generally critical because gravity settling is not employed, the G value can be greatly increased because all that is needed is for the magnetic and non-magnetic particles to collide quickly in the presence of the flocculating polymer. Therefore it is postulated the G value can be increased to about 100 sec⁻¹ and higher, which will speed the flocculation and therefore clarification process. The G value may be greater than about 50 sec⁻¹ and less than about 1000 sec⁻¹ but more preferably in the range of about 100 to about 500 sec⁻¹ in magnetic seeding and separation.

Various forms of magnetic seed material may be used. Among the forms is magnetite, a ferromagnetic form of ferric oxide. Other forms include, but are not limited to, zero valent iron, ferrosilicon, maghemite, jacobsite, trevorite, magnesioferrite, magnetic sulfides like pyrrohotite and greigite, and any other ferromagnetic and ferremagnetic materials that show strong attraction to a magnetic field.

Magnetic seed particle sizes in the range of 30 to 50 microns, as would be characteristic of 90% of material passing a 355 mesh, may be commonly used as magnetic seed for binding or sorbing pollutant particles for removal. Further, for various sorption processes, those that for example may be useful for removing very fine or nano pollutant particles, magnetic seed sizes may range down to approximately 20 nanometers. Magnetic seeding in treatment vessels such as flocculation tanks is typically done at a concentration by weight of magnetic seed of about 0.5 to 1% and which in some cases may up to about 3-5%.

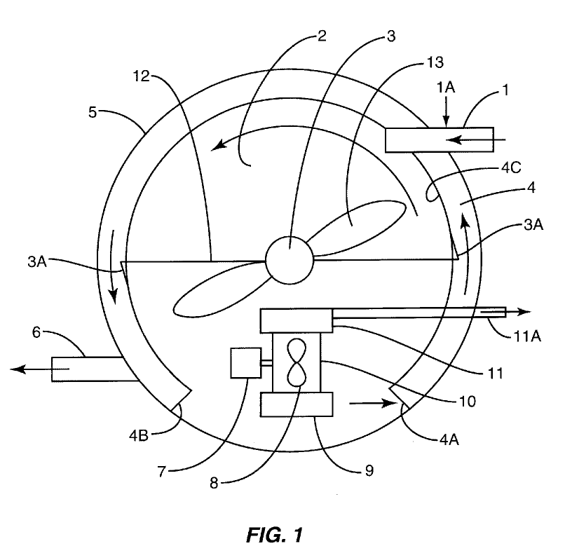

Turning now to the drawings and the design of the tank and final magnetic collector, a final magnetic collector 4 is configured to maintain a substantial residence time in a tank or flocculation chamber while providing a substantial surface area for the final magnetic collector. One way to accomplish this is to locate the floc chamber or zone in the center and bottom of a cylindrical tank and then to extend the final collector around the perimeter of the upper regions of the tank, as illustrated in FIG. 1. In this way, the floc chamber occupies a substantial volume of the tank, increasing the residence time during which the flocculent effectively attaches fine pollutant particles to magnetic seed, such as magnetite, to form composite particles or magnetic floc. This allows the use of magnetic techniques for removal of the fine pollutant particles from the water stream.

The tank can be a cylindrical tank with a circular final magnetic collector 4 extending around the perimeter of an upper portion of a treatment tank 5, as illustrated in FIGS. 1-5. Disposing final magnetic collector 4 around the perimeter of tank 5 increases the surface area of the collector, effectively slowing the motion of the composite particles to less than about 18 inches per second while increasing their residence time in the collector. A speed greater than about 18 inches per second may tend to dislodge the magnetic particles from magnetized surfaces of final magnetic collector 4.

Scaling up the tank design for high flow rate applications requires a larger final magnetic collector 4 which is can be accommodated by placing the collector in proximity to the perimeter of the tank 5. The efficiency of final magnetic collector 4 is reported as the Surface Overflow Rate (SOR) which is measured in gallons per minute per square foot (gpm/ft²) of surface area. The SOR for a traditional gravity clarifier is about 0.25 to 1.00 gpm/ft². The SOR for the present process ranges from about 10 gpm/ft² to 300 gpm/ft² which tends to make magnetic separation technology attractive.

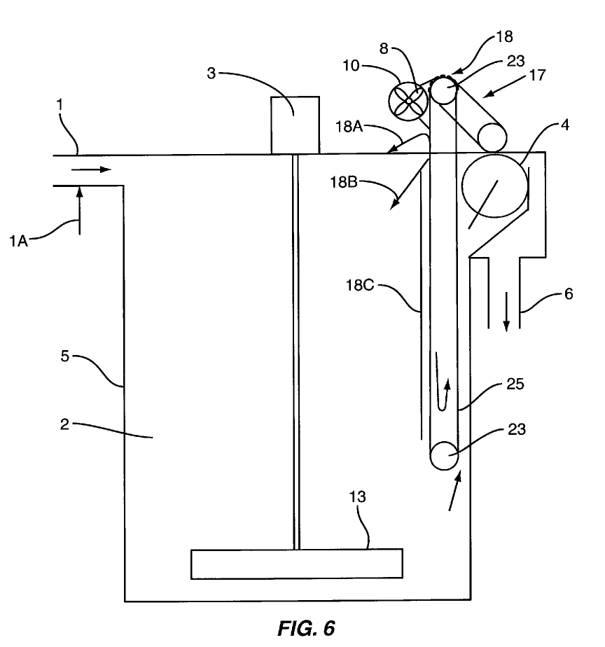

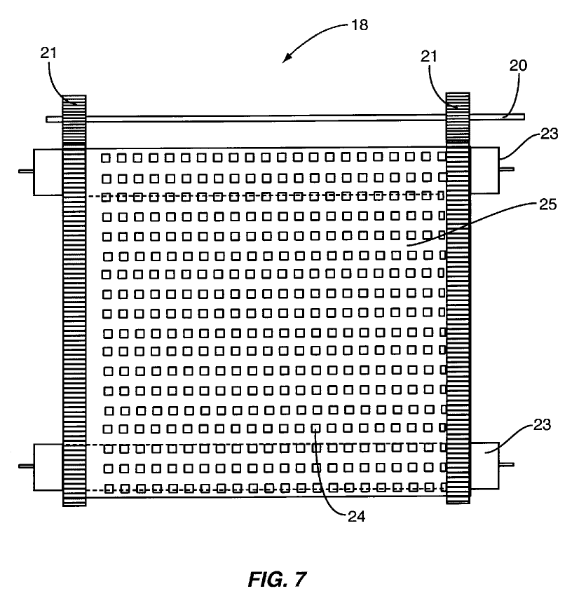

FIG. 1 shows a typical layout for positioning of key treatment elements. The features include the cylindrical tank 5 which is strong and easy to construct, whereby a large portion of the tank volume is dedicated to a flocculation zone 2 and provision of a long flow path in final magnetic collector 4. In some applications, a square or rectangular tank may be utilized in the process since the final magnetic collector 4 can be configured such that it can be disposed along one or more sides of the tank. See, for example, FIGS. 6 and 7 and the description below of a magnetic belt collector used in conjunction with the final magnetic collector. While generally more expensive to construct, a square tank has some improved flocculation characteristics because of improved mixing in that it does not require baffles to increase turbulence as may sometimes be the case with circular tanks.

Referring in particular to FIG. 1, water flows into the tank through a pipe 1 where a flocculating polymer is added at 1A. The water flows into the central flocculation chamber or zone 2 that contains magnetic seed particles (typically magnetite), so that composite magnetic particles, or magnetic floc, are formed and are made up of the pollutant particles bound by the flocculent to the magnetic seed. A flocculation mixer motor 3 and mixer blade 13 are provided to ensure thorough mixing. Water then flows through an opening 4A into an outer shell which contains the final magnetic collector 4 that extends about the perimeter of the tank 5. In this space any of a variety of different types of final magnetic collectors 4 can be installed. In one embodiment, the magnetic seed material or particles will be collected along an inner magnetized surface 4C closest to the flocculation chamber 2 and moved by a mechanical scrapers 3A disposed on ends of arm 12 driven by motor 3. An outlet pipe 6 is communicatively connected to the tank to receive clarified water. Clarified water overflows out pipe 6 while scrapers 3A urge magnetically collected seeded floc along surface 4C and are returned to tank 5 where the floc are ultimately collected on drum (magnetic collector) 9 of a magnetic seed cleaning system disposed in the tank. A typical magnetic seed cleaning system is described in more detail in a co-pending application entitled “A Device and Methods for Shearing Magnetic Floc in a Water Treatment System” filed on Sep. 27, 2007, application Ser. No. 11/862,732, the disclosure of which is expressly included herein by reference. Briefly, a motor 7 drives two magnetic drum devices 9 and 11. The first magnetic drum 9 collects magnetic floc and directs the magnetic floc to a shear device or tank 10 that includes a shear mixer 8 that shears the magnetic particles away from the non-magnetic material of the floc producing a slurry of magnetic seeds and sludge. These materials are separated magnetically on drum 11 with the magnetic seed material being back into the flocculation chamber 2 for reuse and the non-magnetic pollutants, or sludge, being discharged for disposal through line 11A. The location of the first magnetic drum 9 can be advantageously placed in front of the opening 4A so that it removes magnetic particles before they reach the final magnetic collector 4. This dual duty for the first magnetic drum or collector 9 reduces the solids loading on the final magnetic collector 4. The first magnetic collector 9 that removes the magnetic floc for seed separation and cleaning is typically shown as a magnetic drum but can be in other configurations.

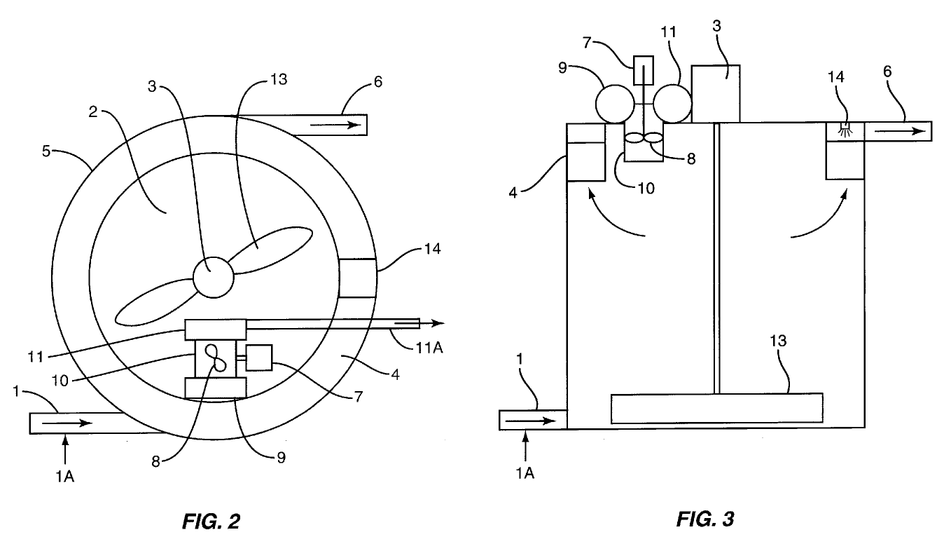

In one embodiment, the final magnetic collector 4 includes a cleaner 14 to continuously clean the final collector 4 as shown in FIGS. 2-5. Cleaner 14 may be of various designs depending on the type of final collector 4 utilized. For example, scrapers 3A shown in FIG. 1 comprise one example of a cleaner.

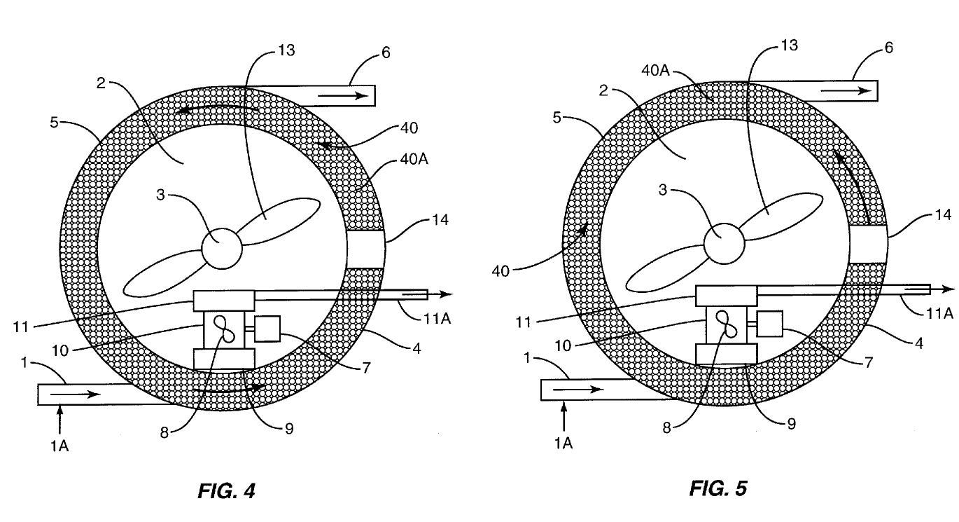

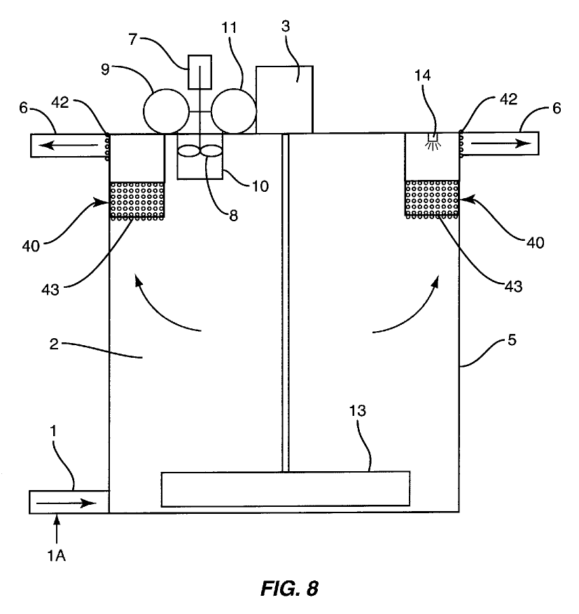

In one embodiment, the magnetic collector may take the form of a bed of magnets 40A in a spaced array disposed over a screen 43 forming the bottom of an annular trough that encircles the perimeter of tank 5. See FIGS. 4 and 8. The magnets 40A may each be encased in a porous shell or cage such that they are held apart in the bed. Water with magnetically-seeded floc flows upward through bed 40, as illustrated in FIG. 8, and the floc are magnetically captured by the magnets 40A in the bed. An exit screen 42 prevents magnetic material that may become dislodged and entrained with the cleaned water from flowing out with the cleaned water. Final magnetic collector 4 may be constructed so as to be buoyant and free to rotate like a carousel propelled by the circular action of water in the flocculation chamber 2. Portions of the final magnetic collector 4 then move past a stationary cleaning device 14. In this embodiment, cleaning device 14 may take the form of a high pressure counter-current water spray system that continuously back flushes the magnetic floc from the magnetized bed 40. In another embodiment, illustrated in FIG. 5, final magnetic collector 4 is stationary and anchored to the tank. A similar back flushing but moving cleaning device 14 is driven around the perimeter of tank 5 cleaning portions of final magnetic collector 4.

As noted above, cleaning device 14 may include a high pressure water spray system that directs cleaning water in a counter flow fashion through magnetized bed 40. Those ordinarily skilled in the art will appreciate that there are various ways to operatively connect and utilize backflushing cleaning devices in water treatment systems such as disclosed herein. Magnetic particles cleaned or flushed from the final magnetic collector bed 40 fall back into the flocculation zone 2 while clarified water is discharged through exit screens 42. See FIG. 8.

In this way, the magnetic floc are continuously returned to tank 5 and from whence they are ultimately collected by a first moving collector 9 of a seed cleaner, sheared in a shear device 8, and scraped back into the tank from a second moving collector 11. Sludge produced by the shear device 8 is ejected through line 11A. See FIGS. 2 and 3.

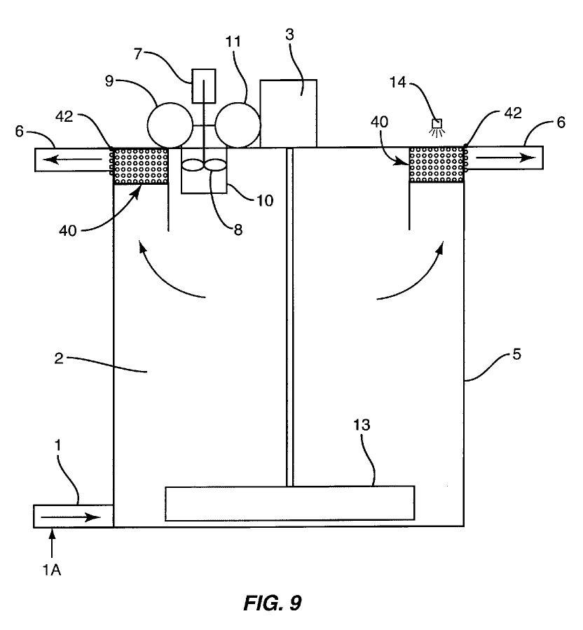

In another embodiment, the magnetic bed 40 may be buoyant and does not have to be retained in its present position by a screen or other support element as illustrated in FIG. 9. As in the foregoing embodiment, retaining screen 42 is employed to prevent stray magnetic materials from leaving tank 5.

The weight of final magnetic collector 4 may be supported by the natural buoyancy of the final magnetic collector by configuring the collector such that it is of sufficient buoyancy to generally float in the water while being horizontally constrained to the wall of tank 5. This approach eliminates costly support structures to hold up the final magnetic collector 4. In cases where it is not convenient to design final magnetic collector 4 as a generally buoyant structure, the collector may be entirely supported on tank 5 or another superstructure.

If first magnetic collector 9 is used to reduce the load on the final magnetic collector 4 as discussed above, then an elongated magnetic belt collector 18 that extends down into the flocculation chamber 2 may be used as the first collector. Details of this elongated magnetic belt are shown in FIGS. 6 and 7. Permanent magnets 24 are affixed to a conveyor belt 25 stretched between two rollers 23. Belt 25 includes a reinforced backing and a pliant surface bonded thereto in a common fashion of conveyor belt design. Magnets 24 are embedded in the belt and the belt is encased in a water-proof jacket. The magnetic conveyor belt is driven by a shaft 20 attached to two drive gears 21. The conveyor belt is affixed with flexible gearing on each edge that engage the drive gears 21.

Referring in particular to FIG. 6, flocculation takes place in the center and bottom of tank 5. The final magnetic collector 4 is located proximate to the tank perimeter. Magnetic belt collector 18 comprises a vertical magnetized conveyor belt 25, driven through drive 17 from the same or a different power source (not shown) as final magnetic collector 4. As the endless belt 25 is driven, magnetic floc are collected on the belt. As seen in FIG. 6, an upper portion of the endless magnetic belt 25 extends above the surface of the water being treated. Once the magnetic floc collected on the belt 25 reaches an upper area, above the surface of the water being treated, the magnetic floc is scraped or removed from the belt and directed into the shear device 8. Here the shear device 8 separates the magnetic floc into magnetic seed and sludge. The sludge is directed away from the system and this is represented at 18A. The clean magnetic seed is directed back into the tank 5 and is represented at 18B. The manner of removing collected magnetic floc from a collector and cleaning the same is similar to that disclosed in my co-pending application entitled “A Device and Methods for Shearing Magnetic Floc in a Water Treatment System” filed on Sep. 27, 2007, and designated by Ser. No. 11/862,732. Reference is also made to the magnetic seeding and subsequent separation techniques disclosed in application Ser. No. 11/503,951 (the '951 application) and U.S. Pat. No. 7,255,793. The disclosures of the '951 application and U.S. Pat. No. 7,255,793 are expressly incorporated herein by reference.

A baffle 18C is disposed adjacent magnetic belt 25 to mechanically isolate the magnetic belt from the turbulence of the mixing in the flocculation zone 2 and to tend to prevent premature magnetic floc from attaching to the magnetic belt.

Clarified water produced by the system of FIG. 6 is directed out outlet 6. Note that a final magnetic collector 4 is disposed between the conveyer belt 25 and the outlet 6. This final magnetic collector 4 will tend to collect magnetic floc and small magnetic particles from the water prior to the particles being discharged out the outlet 6. Magnetic particles collected by the collector 4 are scraped therefrom and permitted to fall back into the tank 5 where eventually the magnetic particles or magnetic floc will be collected by the magnetic belt 25.

The present invention may, of course, be carried out in other specific ways than those herein set forth without departing from the scope and the characteristics of the invention. The present embodiments are therefore to be construed in all aspects as illustrative and not restrictive and all changes coming within the meaning and equivalency range of the appended claims are intended to be embraced therein.

1. A method of treating water utilizing magnetic seeding and magnetic separation, the method comprising: mixing magnetic seed and a flocculant with the water to be treated to form magnetic floc; collecting the magnetic floc on a magnetic collector that extends a substantial distance around an upper perimeter portion of a tank having the magnetic floc and water being treated therein; and removing the magnetic floc from the magnetic collector.

2. The method of claim 1 wherein the magnetic collector includes a magnetized trough that is at least partially submerged in the water being treated in the tank and the method includes directing the magnetic floc and water into and through the magnetized trough and collecting magnetic floc on a wall forming a part of the magnetized trough.

3. The method of claim 1 including directing the magnetic floc and water into an inlet of the collector, moving the magnetic floc and water through the collector, collecting the magnetic floc on a wall that forms a part of the collector, and discharging clarified water from an outlet of the collector.

4. The method of claim 3 wherein the tank assumes a generally cylindrical configuration and wherein the collector extends in a generally circular fashion around the upper perimeter portion of the tank.

5. The method of claim 4 wherein the collector assumes a generally trough configuration.

6. The method of claim 5 including engaging a scraper with the trough and scraping collected magnetic floc from the trough; and collecting the magnetic floc scraped from the trough into a shearing device and shearing the magnetic floc to produce magnetic seed and sludge.

7. The method of claim 1 wherein the collector includes a bed of magnetized particles and the method includes directing the water to be treated through the bed of magnetized particles and collecting magnetic floc on the magnetized particles.

8. The method of claim 7 including cleaning magnetic floc from the magnetized particles by injecting a fluid spray against the magnetized particles and dislodging magnetic floc from the magnetized particles.

9. The method of claim 8 wherein the fluid spray for cleaning the magnetized particles is directed in a direction generally counter to the direction of flow of water through the magnetized particles.

10. The method of claim 1 wherein the collector includes a bed of magnetized particles supported over a perforated surface and the method includes directing the water to be treated upwardly through the perforated surface and through the bed of magnetized particles, resulting in the magnetic floc in the water being collected on the magnetized particles.

11. The method of claim 10 including floating the collector in the water in the tank.

12. The method of claim 11 including cleaning the magnetized particles by providing relative movement between the collector and a fluid injector and directing a fluid spray from the fluid injector into contact with the magnetized particles and dislodging the magnetic floc from the magnetized particles in the process.

13. The method of claim 7 including providing a screen in association with the magnetic collector, and before discharging the water directing the water through the screen to prevent magnetic floc and other pollutants from being discharged with the water.

14. A method of treating water utilizing magnetic seeding and magnetic separation, the method comprising: mixing magnetic seed with a flocculant with the water to form magnetic floc; submerging an endless magnetized belt in the water; driving the endless magnetized belt in the water; collecting magnetic floc on the endless magnetized belt submerged in the water as the belt is driven; and removing the magnetic floc from the endless magnetized belt.

15. The method of claim 14 wherein the belt is generally vertically oriented in the tank and extends a substantial depth in the tank.

16. The method of claim 14 wherein the belt is trained around at least two spaced apart rollers with at least one of the rollers being submerged; and the method includes collecting magnetic floc on a submerged portion of the magnetized belt; driving the magnetized belt and transporting the magnetic floc out of the water; and once out of the water, removing the magnetic floc from the magnetized belt and directing the magnetic floc to a shearing device which shears the magnetic floc producing magnetic seed and sludge.

17. The method of claim 14 wherein the magnetized belt is disposed in a square or rectangular tank that holds the water being treated and wherein the magnetized belt is substantially submerged in the water to be treated and disposed adjacent at least one side of the square or rectangular tank.

18. The method of claim 17 wherein the magnetized belt is trained around two spaced apart rollers with one roller being submerged in the water and the other roller being disposed above the surface of the water, and the method includes driving the magnetized belts such that magnetic floc are collected on the belt and transported to a position above the surface of the water where the magnetic floc is removed from the magnetized belt and cleaned, producing magnetic seed and sludge, and returning the magnetic seed to the tank for reuse.

19. The method of claim 14 including a rotary magnetic collector disposed between an outlet and the belt for serving as a final magnetic collector for collecting magnetic floc from water being discharged from a tank.

20. A water treatment system for treating water by mixing magnetic seed and a flocculant with the water to form magnetic floc, the system comprising: a tank for holding the water to be treated and including a surrounding wall structure; a mixer disposed in the tank for maintaining the magnetic floc in suspension and moving the magnetic floc in the tank; a first magnetic collector disposed adjacent the surrounding wall of the tank and extending around a substantial upper perimeter portion of the tank; and the tank having a flocculation zone that is disposed at least partially inwardly of the first magnetic collector such that at least some of the magnetic floc in the tank moves outwardly from the flocculation zone to the first magnetic collector extending around a substantial upper perimeter portion of the tank.

21. The water treatment system of claim 20 including a device for removing magnetic floc collected on the first magnetic collector; and wherein the water treatment system includes at least one additional magnetic collector for collecting magnetic floc removed from the first magnetic collector.

22. The water treatment system of claim 20 including a second magnetic collector disposed inwardly of the first magnetic collector.

23. A water treatment system for treating water by mixing magnetic seed and a flocculant with the water to form magnetic floc, the system comprising: a tank for holding the water to be treated and including a surrounding wall structure; a mixer disposed in the tank for maintaining the magnetic floc in suspension and for moving the magnetic floc in the tank; a magnetized endless belt disposed in the tank and configured to be at least partially submerged in the water contained within the tank; the tank having a flocculation zone that is disposed adjacent the magnetized endless belt where the magnetic floc is maintained in suspension; and a drive for driving the magnetized endless belt such that as the magnetized endless belt is driven, magnetic floc is collected on the magnetized endless belt.

24. The water treatment system of claim 23 including a cleaning system disposed adjacent the magnetized endless belt for receiving magnetic floc from the endless belt and cleaning the magnetic floc by shearing the magnetic floc to form magnetic seed and sludge.

25. The water treatment system of claim 23 wherein the tank includes an outlet for discharging clarified water; and a magnetic collector disposed between the outlet and the magnetized endless belt for collecting magnetic floc from water being discharged out the outlet of the tank.
